(19) United States
(12) Patent Application Publication
(10) Pub. No.: US 2017/0203549 A1
(43) Pub. Date: Jul. 20, 2017

(54) STONE VENEER TABLE TOP

(71) Applicant: Scott Garrison, Fitchburg, WI (US)

(72) Inventor: Scott Garrison, Fitchburg, WI (US)

(21) Appl. No.: 15/409,437

(22) Filed: Jan. 18, 2017

Related U.S. Application Data
(60) Provisional application No. 62/280,283, filed on Jan. 19, 2016.

(51) Int. Cl. B32B 21/14; A47B 13/08; B32B 17/06; B32B 13/04; B32B 7/12; B32B 15/04

(52) U.S. Cl. CPC B32B 21/14; B32B 7/12; B32B 15/04; B32B 17/06; B32B 13/04; A47B 13/086; B32B 2318/04; B32B 2309/105; B32B 2479/00

(57) ABSTRACT

A table top includes a stone veneer presenting a single unitary piece of stone as the top surface of the stone veneer, wherein the stone veneer defines a veneer perimeter comprising a rectangle having a width of at least 20 inches (50.8 centimeters) and a length of at least 40 inches (101.6 centimeters), wherein the stone veneer has a veneer thickness, a substrate defining a substrate perimeter and having a substrate thickness, and an adhesive securing the bottom surface of the stone veneer to the top surface of the substrate, wherein the veneer perimeter and the substrate perimeter are substantially the same shape and size, wherein the veneer thickness is at least 1 millimeter (0.03937 inch) and not greater than 6 millimeters (0.2362 inch), wherein the substrate thickness is at least 3 millimeters (0.1181 inch), and wherein the table top weighs less than 4 pounds per square foot (191.5 Newtons per square meter).

### CROSS-REFERENCE TO RELATED PATENT APPLICATIONS

This application claims the benefit of U.S. application Ser. No. 62/280,283, filed Jan. 19, 2016, which is incorporated herein by reference in its entirety.

### BACKGROUND

The present invention relates generally to the field of furniture, and more particularly to the field of table tops. Stone table tops are becoming increasingly popular for all types of tables, including indoor and outdoor furniture. While providing many advantages, stone table tops can be both heavy and expensive. Stone table tops can also be exposed to heating and cooling cycles (e.g., during shipping, when used in outdoor furniture, etc.) that cause the stone table top to expand and contract, potentially damaging the table top.

Stone veneer table tops in which a veneer or a layer of multiple pieces of stone is attached to a fiberglass substrate are known in the furniture industry. The multiple pieces of stone are typically arranged in a mosaic or other pattern. The largest individual piece of stone veneer used in previously known stone veneer table tops is approximately 144 square inches (929 square centimeters) (i.e., 12 inches (30.48 centimeters) by 12 inches (30.48 centimeters)). The fiberglass substrate of previously known stone veneer table tops is directly applied to the stone layer of multiple pieces of stone so that the fiberglass adheres directly to the stone. The fiber glass substrate may include a rigid metal support structure within the fiberglass. The stone veneer of previously known stone veneer table tops typically has a thickness of 8-15 millimeters (mm) (0.315-0.5906 inch) or higher. Previously known stone veneer tables top typically weigh between approximately 4.6 pounds per square foot (220.2 Newtons per square meter) or more, so that a 70 inch (177.8 centimeters) by 40 inch (101.6 centimeters) table top weighs approximately 90 pounds (40.82 kilograms) or more.

### SUMMARY

One embodiment of the invention relates to a table top including a stone veneer presenting a single unitary piece of stone as the top surface of the stone veneer, wherein the stone veneer defines a veneer perimeter comprising a rectangle having a width of at least 20 inches (50.8 centimeters) and a length of at least 40 inches (101.6 centimeters), wherein the stone veneer has a veneer thickness, a substrate defining a substrate perimeter and having a substrate thickness, and an adhesive securing the bottom surface of the stone veneer to the top surface of the substrate, wherein the veneer perimeter and the substrate perimeter are substantially the same shape and size, wherein the veneer thickness is at least 1 millimeter (0.03937 inch) and not greater than 6 millimeters (0.2362 inch), wherein the substrate thickness is at least 3 millimeters (0.1181 inch), and wherein the table top weighs less than 4 pounds per square foot (191.5 Newtons per square meter).

Another embodiment of the invention relates to a table top including a stone veneer defining a veneer perimeter and having a veneer thickness, a substrate defining a substrate perimeter and having a substrate thickness, and an adhesive securing the bottom surface of the stone veneer to the top surface of the substrate, wherein the veneer perimeter and the substrate perimeter are substantially the same shape, wherein the veneer thickness is at least 1 millimeter (0.03937 inch) and not greater than 6 millimeters (0.2362 inch), wherein the substrate thickness is at least 3 millimeters (0.1181 inch), and wherein the table top weighs less than 4 pounds per square foot (191.5 Newtons per square meter).

Another embodiment of the invention relates to a table top including a stone veneer defining a veneer perimeter and having a veneer thickness, a substrate defining a substrate perimeter and having a substrate thickness, and an adhesive securing the bottom surface of the stone veneer to the top surface of the substrate, wherein the table top weighs less than 4 pounds per square foot (191.5 Newtons per square meter).

Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, in which:

FIG. 1 is a perspective view of a stone veneer table top according to an exemplary embodiment;

FIG. 2 is an exploded view of the stone veneer table top of FIG. 1;

FIG. 3 is a section view of the stone veneer table top of FIG. 1 along line 3-3;

FIG. 4 is a table according to an exemplary embodiment including the stone veneer table top of FIG. 1;

FIG. 5 is a section view of the table of FIG. 4 along line 4-4;

FIG. 6 is a section view of the table of FIG. 4 according to an alternative embodiment of the stone veneer table top of FIG. 1;

FIG. 7 is a perspective view of a table according to an exemplary embodiment including an alternative embodiment of the stone veneer table top of FIG. 1;

FIG. 8 is a perspective view from above of a table according to an exemplary embodiment including an alternative embodiment of the stone veneer table top of FIG. 1;

FIG. 9 is a perspective view from below of the table of FIG. 8;

FIG. 10 is a perspective view from above of a table according to an exemplary embodiment including an alternative embodiment of the stone veneer table top of FIG. 1;

FIG. 11 is a perspective view from above of a table according to an exemplary embodiment including an alternative embodiment of the stone veneer table top of FIG. 1;

FIG. 12 is an exploded view of a portion of the table of FIG. 11;

FIG. 13 is a perspective view from below of a table according to an exemplary embodiment including an alternative embodiment of the stone veneer table top of FIG. 1;

FIG. 14A is a sectional view of a stone veneer table top according to an exemplary embodiment;

FIG. 14B is a sectional view of the stone veneer table top of FIG. 14A according to an alternative embodiment; and

FIG. 15 is a perspective view from above of a portion of the stone veneer table top of FIG. 14A.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

The stone veneer table tops described in the application provide several advantages over previously known stone table tops. The stone veneer table tops described in the application use much less stone than previously known stone veneer table tops, and even less stone than a solid stone table top, which saves on material costs and greatly reduces weight. In some embodiments, the stone veneer table tops described in the application weigh approximately 2.3 pounds per square foot (110.1 Newtons per square meter) or less. In other embodiments, the stone veneer table tops described in the application weigh approximately 3.8 pounds per square foot (181.9 Newtons per square meter) or less. The stone veneer table tops described in the application have a lower profile (i.e., thickness) and are lower in weight than previously known stone table tops. These features make the stone veneer table tops described in the application easier to move, load, secure, etc. during shipping than previously known stone table tops, which makes the tabletops described in the application less likely than previously known stone table tops to be damaged during shipping. The stone veneer table tops described in the application are also better able be subjected to thermal cycling (e.g., cyclical heating and cooling) without experiencing damage than previously known stone veneer table tops. The adhesive used to secure the stone veneer to the substrate provides flexibility to the table top described in the application. This flexibility allows for some relative movement between the stone veneer and the substrate so that the stone veneer and the substrate may expand and contract at different rates due to heating and cooling without damaging the table top. The adhesive functions in part as a buffer layer between the stone veneer and the substrate and provides the flexibility needed to allow the stone veneer and the substrate limited movement relative to one another sufficient to avoid damage due to thermal cycling. Previously known stone veneer table tops, where a fiberglass substrate is directly applied to the stone veneer frequently experience damage (e.g., the stone veneer or substrate cracking or breaking, the substrate detaching from the stone veneer) because the stone veneer and fiberglass substrate are directly attached to one another and expand and contract at different rates when heated and cooled. Previously known stone veneer table tops are formed from multiple pieces of stone, which requires that the pieces of stone be presented in some sort of mosaic or pattern. Some embodiments of the stone veneer table tops described in the application present a single unitary piece or sheet of stone as the top surface of the table top. This is not possible with previously known stone veneer table tops that must present multiple pieces of stone arranged in a pattern as the top surface of the table top. The single unitary piece or sheet of stone as the top surface is easier to clean and maintain than the multiple piece stone top surfaces of previously known stone veneer table tops because there are no gaps between the pieces of stone in which debris can be trapped and which may need to be resealed or grouted during the lifetime of the table top.

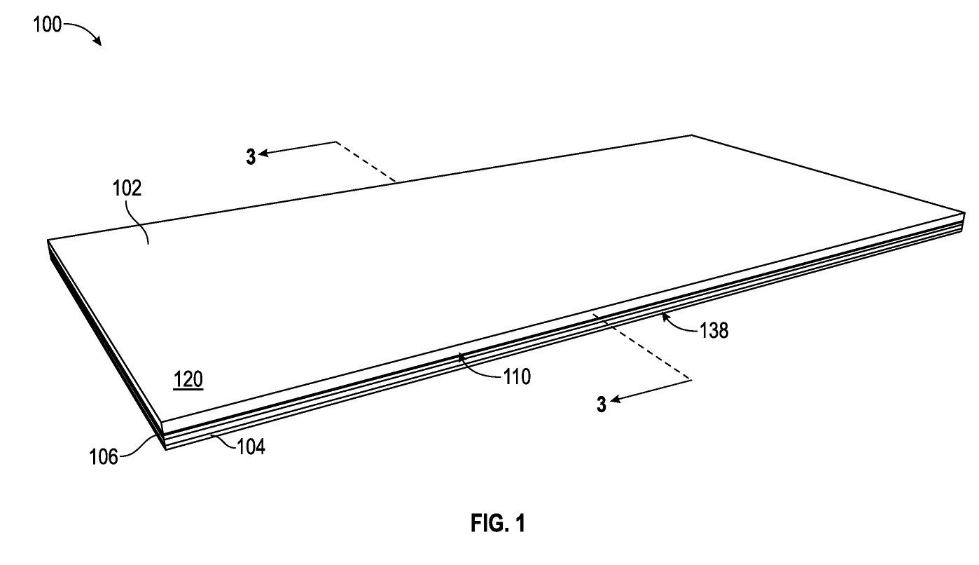

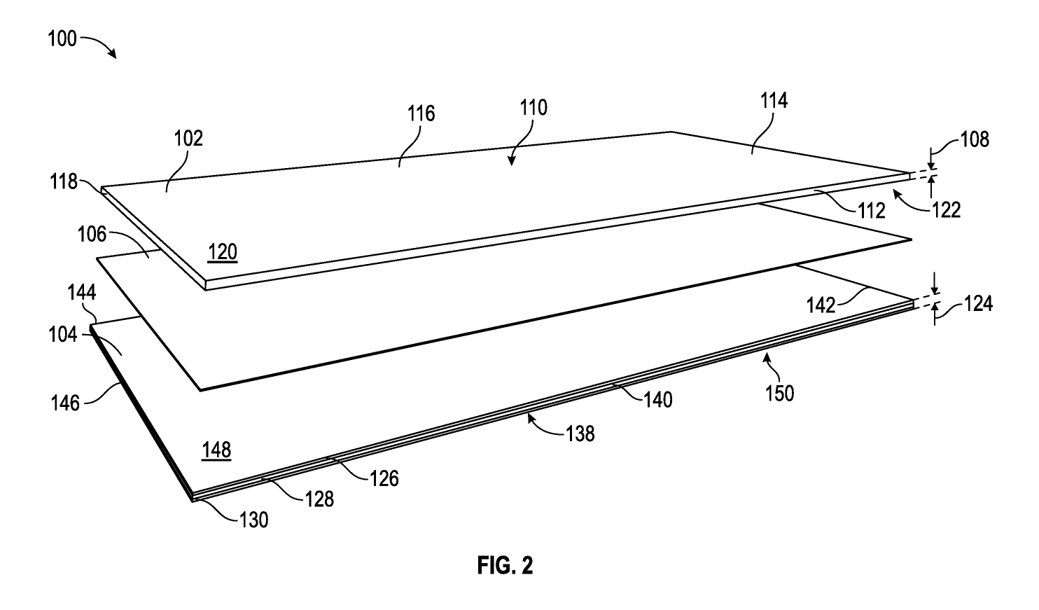

Referring to FIGS. 1-3, a stone veneer table top 100 is illustrated according to an exemplary embodiment. The stone veneer table top 100 includes a stone veneer 102 and a substrate 104. An adhesive 106 secures the stone veneer 102 to the substrate 104. As illustrated, the stone veneer table top is rectangular, though other shapes are also possible (e.g., circular, square, oval, etc.). The stone used in the stone veneer 102 may be slate, sandstone, schist, granite, marble, concrete, etc.

The stone veneer 102 has a thickness 108 and defines a perimeter 110. The thickness 108 is relatively thin compared to traditional stone veneers used in previously known stone veneer table tops and to the stone used in previously known solid stone table tops. In some embodiments, the thickness 108 is 6 mm (0.2362 inch) or less. In some embodiments, the thickness 108 is 5 mm (0.1969 inch) or less. In some embodiments, the thickness 108 is 4 mm (0.1575 inch) or less. In some embodiments, the thickness 108 is 3 mm (0.1181 inch) or less. In some embodiments, the thickness 108 is 2 mm (0.07874 inch) or less. In some embodiments, the thickness 108 is 1 mm (0.03937 inch) or less.

The perimeter 110 establishes the shape of the table top 100. In some embodiments, the perimeter is a rectangle having a length between 18 inches (45.72 centimeters) and 100 inches (254 centimeters) and a width between 18 inches (45.72 centimeters) and 70 inches (177.8 centimeters). For example, in some embodiments, the perimeter 110 may be a rectangle 70 inches (177.8 centimeters) long by 40 inches (101.6 centimeters) wide. Other embodiments have perimeters 110 of 66 inches (167.6 centimeters) by 38 inches (96.52 centimeters), 60 inches (152.4 centimeters) by 40 inches (101.6 centimeters), 42 inches (106.7 centimeters) by 42 inches (106.7 centimeters), 38 inches (96.52 centimeters) by 38 inches (96.52 centimeters), 40 inches (101.6 centimeters) by 20 inches (50.8 centimeters), 24 inches (60.96 centimeters) by 24 inches (60.96 centimeters), 20 inches (50.8 centimeters) by 20 inches (50.8 centimeters), or 18 inches (45.72 centimeters) by 18 inches (45.72 centimeters). As illustrated, perimeter 110 includes four sides, 112, 114, 116 and 118. In other embodiments, the perimeter 110 may define more or fewer sides, for example an octagon. In still other embodiments, the perimeter 110 may be an oval or circular, or otherwise include rounded or curved sides (e.g., a rectangle with rounded or curved corners, a rectangle with one or more rounded or curved sides, etc.). In some embodiments, the perimeter 110 is a circle having a diameter between 20 inches (50.8 centimeters) and 54 inches (137.2 centimeters). The perimeter 110 may also be defined in terms of surface area (e.g., a rectangle 40 inches (101.6 centimeters) by 20 inches (50.8 centimeters) has a surface area of 800 square inches (5161 square centimeters).

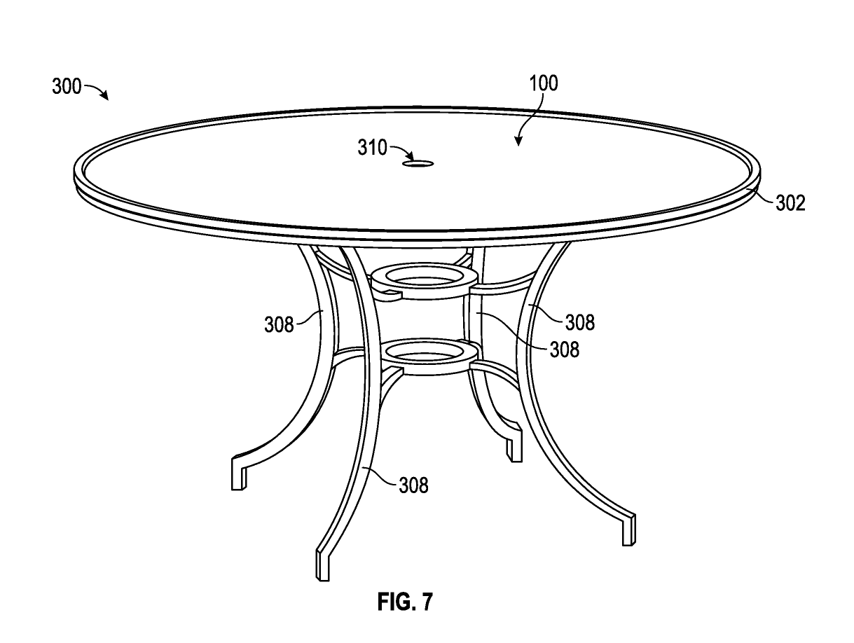

The stone veneer 102 also includes a top surface 120 and a bottom surface 122. In a preferred embodiment, the stone veneer 102 presents a single unitary piece or sheet of stone as the top surface 120 of the table top 100. In some embodiments, the single unitary piece or sheet of stone presented as the top surface 120 of the table top 100 includes a hole or aperture for receiving an umbrella stand (e.g., hole 310 shown in FIG. 7). In some embodiments, the stone veneer 102 may be formed of multiple pieces for aesthetic reasons. For example, the stone veneer 102 may be a series of tiles that form a pattern or other aesthetic design. The multiple pieces may be of differing types of stone. The bottom surface 122 of the stone veneer 102 may be conditioned or abraded so that the bottom surface 122 better adheres to the adhesive 106. For example, the bottom surface 122 may be abraded or roughened by a series of indentations, holes or other surface textures appropriate for increasing the interaction between the adhesive 106 and the bottom surface 122. In some embodiments of the stone veneer table top described herein, the stone veneer 102 is cut into a pattern simulating a tile pattern (e.g., by a manual router, by a computer numberic control router, etc.) and the cut pattern is then filled with grout or other filler substance to present a table top that appears to be a tiled table top, but that is formed by a single piece of stone veneer. This approach provides the appearance of a tiled table top, but reduces manufacturing time and expense.

In some embodiments, the stone veneer 102 may be a flexible stone veneer. Flexible stone veneers are formed by adhering a thin layer of fiberglass or other backing to a relatively thick piece of stone and then peeling or pulling the backing away to remove a thin layer of stone along with the backing. This results in a sheet of flexible stone veneer in which the thickness of the stone layer may range between 0.3 mm (0.01181 inch) and 1.5 mm (0.05906 inch) and the overall thickness of the flexible stone veneer (i.e., including both stone and backing) may range between 1.5 mm (0.05906 inch) and 6 mm (0.2362 inch). In embodiments where the stone veneer 102 is a flexible stone veneer, the top surface 120 is stone and the bottom surface 122 is the backing used to remove the thin layer of stone.

The substrate 104 is rigid and provides additional thickness for the table top 100 (i.e., in addition to the stone veneer 102) so that the overall rigidity and thickness of the table top 102 are suitable for use as a table top (e.g., in view of industry standards, customer expectations, etc.). The substrate 104 has an overall thickness 124. In some embodiments, the overall thickness 124 is 7 mm (0.2756 inch) or less. In some embodiments, the overall thickness 124 is 6 mm (0.2362 inch) or less. In some embodiments, the overall thickness 124 is 5 mm (0.1969 inch) or less. In some embodiments, the overall thickness 124 is 4 mm (0.1575 inch) or less. In some embodiments, the overall thickness 124 is 3 mm (0.1181 inch) or less. In some embodiments, the substrate 104 is a piece of metal (e.g., aluminum, etc.), glass (e.g., tempered glass, etc.), plastic (e.g., PVC, etc.), wood (e.g., treated wood suitable for use outdoors), or other appropriate construction material (e.g., autoclaved aerated concrete (AAC), which may also be known as autoclaved cellular concrete (ACC) or autoclaved lightweight concrete (ALC), etc.). In some embodiments, the substrate 104 is a piece of metal composite material (MCM) formed by two metal skins or layers bonded to an interior plastic core or layer, creating a “sandwich” panel. MCM is a light-weight yet sturdy material that provides a very high rigidity. The rigidity is achieved in part due to the interaction between the two outer metal layers and the internal plastic layer. When under a flexural load, the plastic layer is subjected to shear loads and creates a distance between the metal layers, which are subjected to in-plane stresses with one metal layer in tension and the other metal layer in compression.

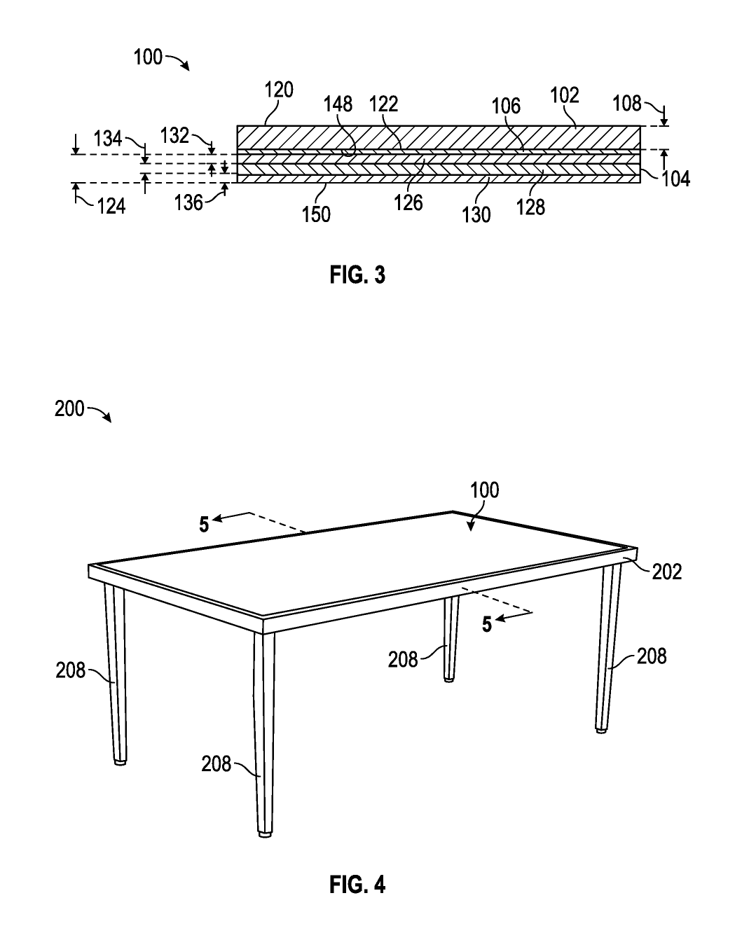

Referring to FIG. 3, in the illustrated embodiment, a panel of aluminum composite material (ACM), a type of MCM, is used as the substrate 104 and includes a top layer 126 formed from aluminum, an interior layer 128 formed from plastic and a bottom layer 130 formed from aluminum. The top layer 126 has a thickness 132. The interior layer 128 has a thickness 134. The bottom layer 130 has a thickness 136. In the illustrated embodiment, the top layer 126 and the bottom layer 130 have substantially the same thickness (e.g., 0.4-0.8 mm (0.01575-0.0315 inch)) and the thickness 134 of the interior layer (e.g., 2-3 mm (0.07874-0.1181 inch)) is greater than the thickness 132 of the top layer and the thickness 136 of the bottom layer.

The substrate 104 defines a perimeter 138. As illustrated, the perimeter 138 includes four sides, 140, 142, 144 and 146. The three layers 126, 128 and 130 all share the same shape and size and therefore collectively define the perimeter of the substrate 104. In some embodiments, the perimeter 110 of the stone veneer 102 and the perimeter 138 of the substrate 104 are substantially the same shape and size.

The top layer 126 defines a top surface 148 of the substrate 104. The bottom layer 130 defines the bottom surface 150 of the substrate 104. The top surface 148 of the substrate may be conditioned or abraded to better adhere to the adhesive 106.

The adhesive 106 is a flexible adhesive used to secure the stone veneer 102 to the substrate 104. In different embodiments, the adhesive is a polyurethane adhesive, a urethane adhesive, silicon adhesive, an epoxy, or other appropriate construction adhesive. The flexibility provided by the adhesive 106 helps the table top 100 be subjected to thermal cycling without damaging the stone veneer 102 or the substrate 104.

In some embodiments, the table top 100 is assembled by applying the adhesive 106 to the bottom surface 122 of the stone veneer 102 and then bringing the top surface 148 of the substrate 104 into contact with the adhesive 106 to secure the stone veneer 102 to the substrate 104. In other embodiments, the adhesive is first applied to the top surface 148 of the substrate 104. In some embodiments, after the stone veneer 102 is secured to the substrate 104, one or the other is cut to size so that the perimeter 110 of the stone veneer 102 matches the perimeter 138 of the substrate 104. In some embodiments, the assembled table top 100 is sealed or weatherproofed. In some embodiments, a hole for receiving an umbrella stand is formed through the assembled table top (e.g., hole 310 shown in FIG. 7).

In some embodiments, the table top 100 weighs approximately 4.0 pounds per square foot (191.5 Newtons per square meter) or less. When the stone veneer 102 is a flexible stone veneer and the substrate 104 is ACM, the table top 100 weighs approximately 2.5 pounds per square foot (119.7 Newtons per square meter) or less. For a 70 inch (177.8 centimeters) by 40 inch (101.6 centimeters) table top, this results in a total weight of approximately 49 pounds (22.23 kilograms), much less than approximately 90 pounds (40.82 kilograms) for a previously known stone veneer table top of the same size. When the stone veneer 102 is a flexible stone veneer and the substrate 104 is AAC, the table top weighs approximately 3.8 pounds per square foot (181.9 Newtons per square meter) or less. For a 70 inch (177.8 centimeters) by 40 inch (101.6 centimeters) table top, this results in a total weight of approximately 74 pounds (33.57 kilograms).

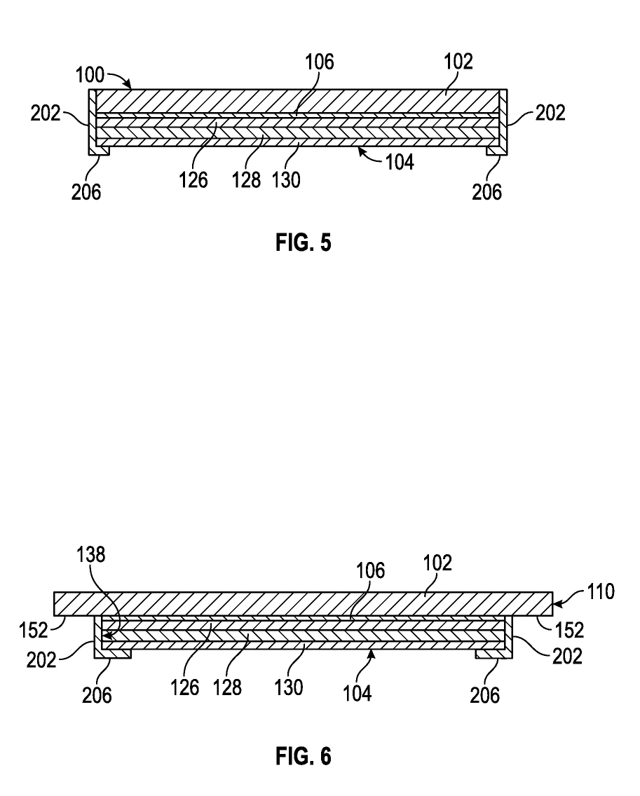

FIGS. 4-5 illustrate a table 200 according to an exemplary embodiment. The table 200 includes a support frame 202 defining a perimeter 204 similar in shape to the perimeter of the stone veneer table top 100. As illustrated the perimeter 204 of the frame 202 and the perimeter of the stone veneer table top 100 are rectangular. The frame 202 includes a rim 206 or other support device configured to support the stone veneer table top 100. One or more legs 208 or other support structures extend from the frame 202 to support the table 200.

In some embodiments, as illustrated in FIG. 6, the perimeter 110 of the stone veneer 102 may be larger in size than the perimeter 138 of the substrate 104 so that the table top 100 presents a floating table top. In these embodiments, the stone veneer 102 extends past the edges of the substrate 104 bends around a rounded corner 152 of the substrate 104 to present a vertical surface 153. The substrate 104 is attached to the table support frame 202 with an overhang 154 extending past the edges of the support frame 202 and thereby presenting a floating table top.

FIG. 7 illustrates a table 300 according to an exemplary embodiment. The table 300 includes a round stone veneer table top 100 supported by a round support frame 302. One or more legs 308 or other support structures extend from the frame 302 to support the table 300. As illustrated in FIG. 7, the table top 100 includes a hole or aperture 310 for receiving an umbrella stand.

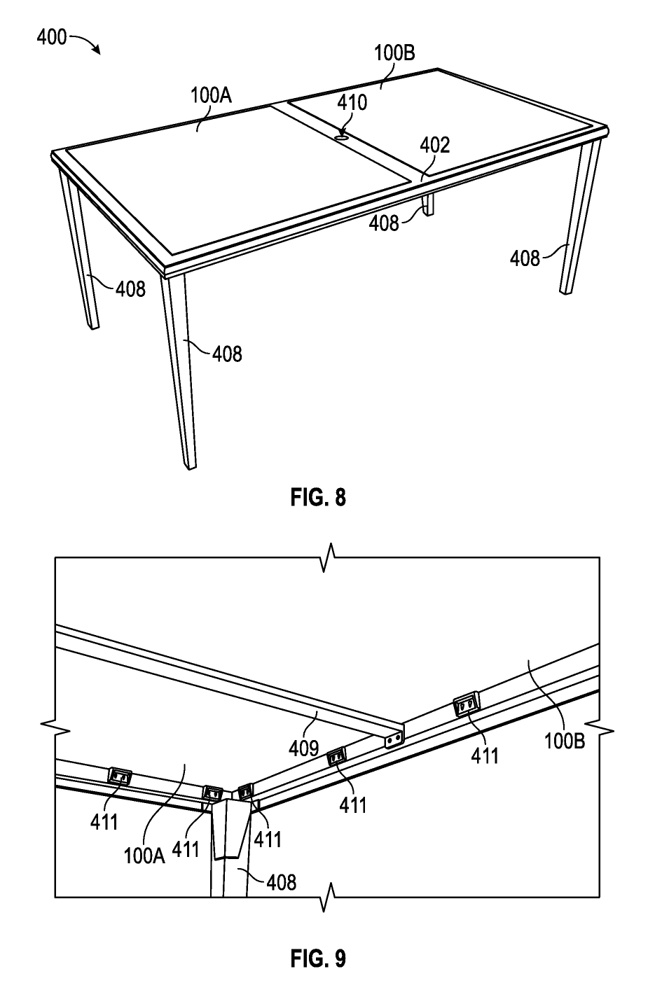

FIGS. 8-9 illustrate a table 400 according to an exemplary embodiment. The table 400 includes two rectangular stone veneer table tops 100A and 100B each attached to a table support frame 402. One or more support bars or members 409 are secured to (e.g., fastened, riveted, welded, etc.) and extend across the support frame 402 to support the table top. Also, multiple clips 411 including a support ledge are secured (e.g., fastened, riveted, welded, etc.) to the support frame 402 so that the support ledge contacts and supports the bottom of the table top. The clips 411 can be made of plastic, metal, or other appropriate material. One or more legs 408 or other support structures extend from the frame 402 to support the table 400. As illustrated in FIG. 8, the table support frame 402 includes a hole or aperture 410 for receiving an umbrella stand. In some embodiments, a table includes multiple stone veneer table tops (e.g., two, three, four, five, six, etc. table tops).

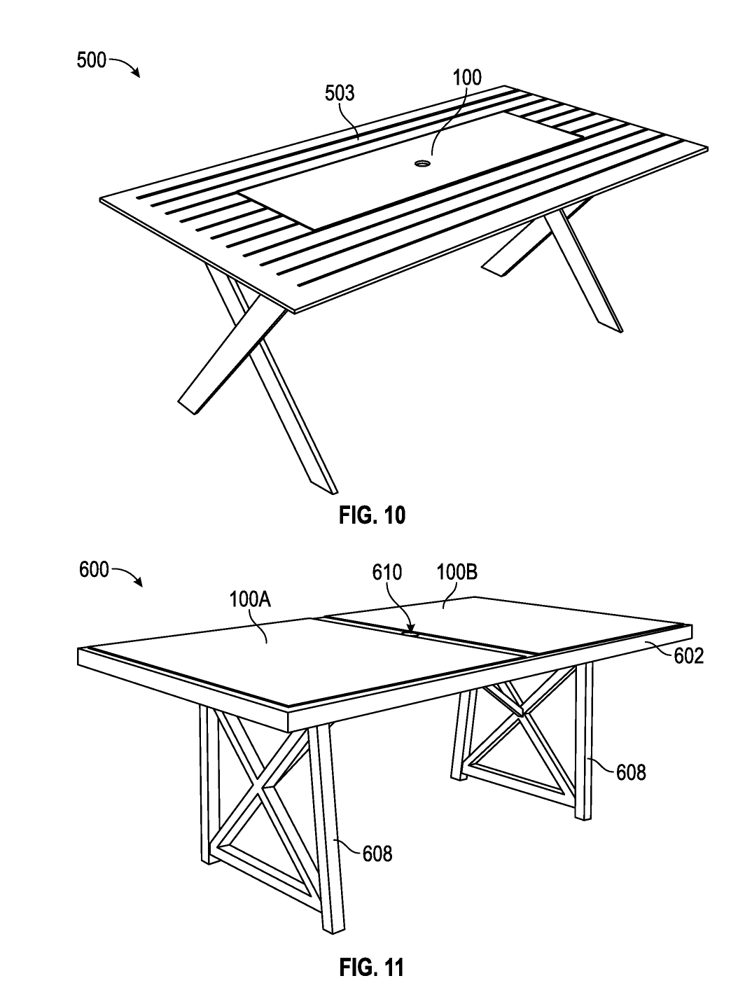

FIG. 10 illustrates a table 500 according to an exemplary embodiment. The table 500 includes a rectangular stone veneer table top 100 used as an accent within a larger table top 503. Alternatively, two or more tone veneer table tops can be used within a larger table top in a similar manner.

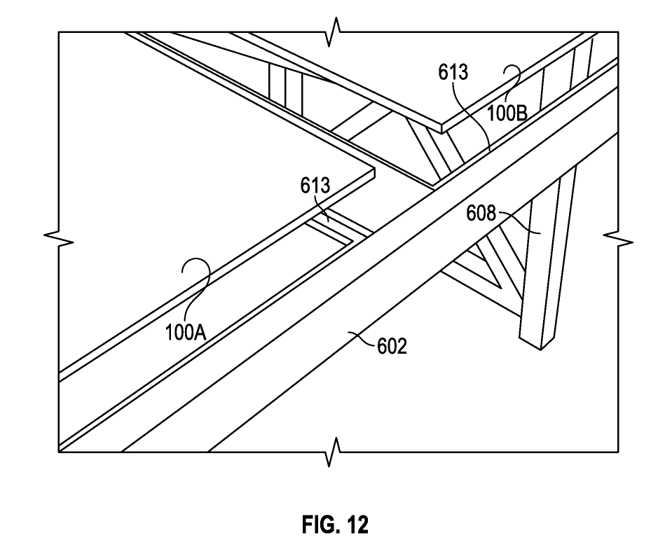

FIGS. 11-12 illustrate a table 600 according to an exemplary embodiment. The table 600 includes two rectangular stone veneer table tops 100A and 100B each attached to a table support frame 602 (though shown as a single piece, table tops 100A and 100B are similar to the table top 100 described above). As illustrated in FIG. 12, each table top 100A and 100B is inlaid into a recessed frame 613 within the table support 602. One or more legs 608 or other support structures extend from the frame 602 to support the table 600. The table support frame 602 includes a hole or aperture 610 for receiving an umbrella stand.

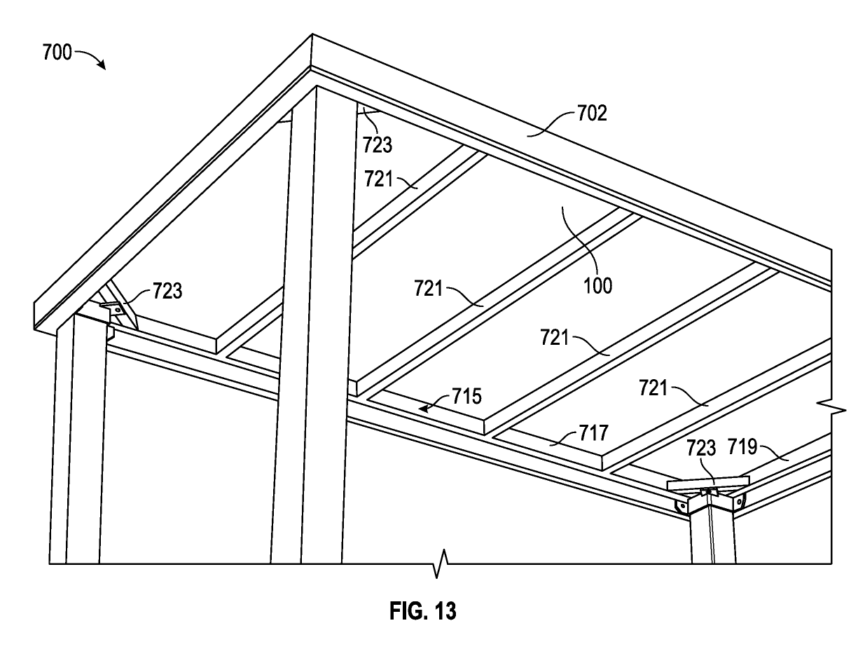

FIG. 13 illustrates a table 700 according to an exemplary embodiment. The table 700 includes a rectangular stone veneer table top 100 attached to a mounting frame 715. The mounting frame 715 is formed by a number of support bars or members that are secured (e.g., fastened, riveted, welded, etc.) to one another. In the illustrated embodiment, the mounting frame 715 includes two longitudinal members 717, two transverse members 719, four support members 721, and four corner pieces 723. The mounting frame 715 is secured (e.g., fastened, riveted, welded, etc.) to a table support frame 702. The mounting frame 715 may be place on top of the table support frame 702, inlaid within a recessed frame in the table support frame 702, or positioned in other appropriate manner relative to the table support frame 702. Alternatively, the mounting frame could be formed with C-shaped channels as the longitudinal and transverse members, where the table top is captured within the opening in the “C” of each channel. Support members and corner pieces may be included in this embodiment.

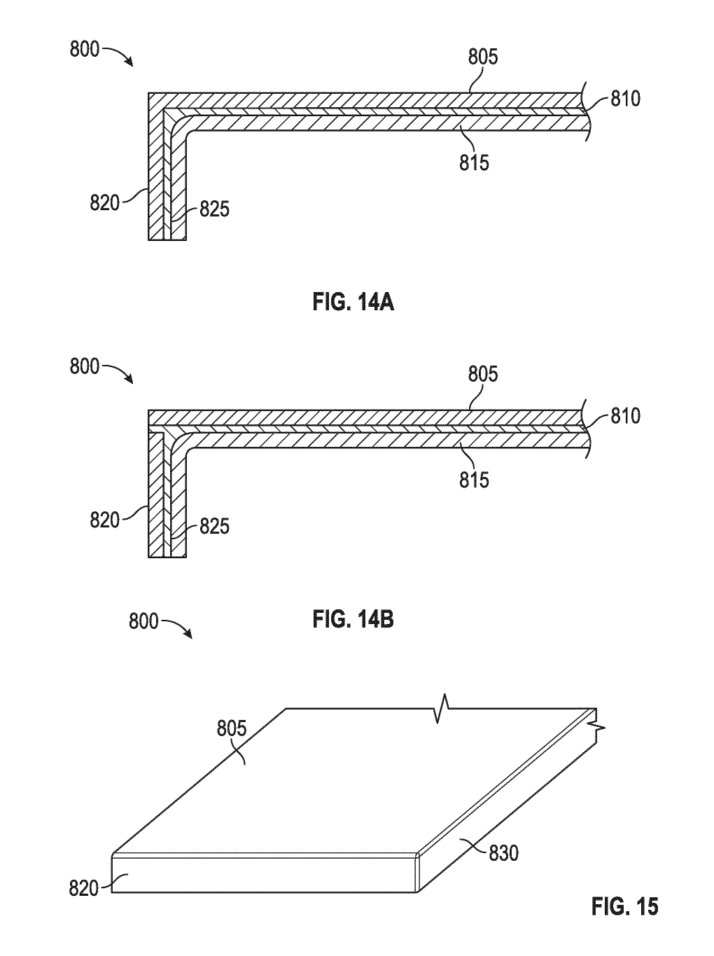

Referring to FIGS. 14-15, a stone veneer table top 800 is illustrated according to an exemplary embodiment. The stone veneer table top 800 includes a substrate 815 that includes a top portion that is arranged horizontally in a normal use position and a flange, protrusion, or lip portion that extends downward from the perimeter of the top portion. In some embodiments, the substrate 815 is formed by bending a piece of sheet metal into this configuration. The substrate 815 may be square, rectangular, other polygons, circular, or other shapes appropriate for a table top. A stone veneer 805 is attached to the top portion of the substrate 815 by an adhesive 810 located between the first stone veneer 805 and the substrate 815. As shown in FIG. 14A, the stone veneer 805 may be bent to correspond to the top portion and the lip portion of the substrate 815 so that a portion 820 of the veneer 805 is arranged vertically along the lip portion of the substrate 815 and attached to the substrate 815 by adhesive 825. Alternatively, as shown in FIG. 14B, the portion 820 of the stone veneer is a separate second stone veneer 820 is attached to the lip portion of the substrate 815 by adhesive 825. In some embodiments the edges of the stone veneers 805 and 820 are chamfered or otherwise formed to present a continuous outer stone surface for the table top 800. As shown in FIG. 15, the stone veneer 805 may include multiple portions 820 and 830 that are bent and attached to the lip portion of the substrate 805 to present a continuous outer stone surface for the table top 800. Alternatively, the portion 830 of the stone veneer is a separate stone veneer 830 attached to the lip portion of the substrate 805 by adhesive. The stone veneer table top 800 includes as many bent portions of the stone veneer 805 or separate stone veneers as needed to cover the exterior surface of the lip portion of the substrate 815 (e.g., four portions or four separate stone veneers for a square or rectangular table top).

The construction and arrangement of the apparatus, systems and methods as shown in the various exemplary embodiments are illustrative only. Although only a few embodiments have been described in detail in this disclosure, many modifications are possible. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges or geometric relationships provided. Accordingly, these terms should be interpreted as indicating that insubstantial or inconsequential modifications or alterations of the subject matter described and claimed are considered to be within the scope of the invention as recited in the appended claims.

What is claimed is:

1. A table top, comprising:
a stone veneer presenting a single unitary piece of stone as the top surface of the stone veneer, wherein the stone veneer defines a veneer perimeter comprising a rectangle having a width of at least 20 inches and a length of at least 40 inches, wherein the stone veneer has a veneer thickness;
a substrate defining a substrate perimeter and having a substrate thickness; and
an adhesive securing the bottom surface of the stone veneer to the top surface of the substrate;
wherein the veneer perimeter and the substrate perimeter are substantially the same shape and size;
wherein the veneer thickness is at least 1 millimeter and not greater than 6 millimeters;
wherein the substrate thickness is at least 3 millimeters; and
wherein the table top weighs less than 4 pounds per square foot.

2. The table top of claim 1, wherein the veneer perimeter comprises a rectangle having a width of at least 40 inches and a length of at least 70 inches.

3. The table top of claim 1, wherein the substrate comprises metal.

4. The table top of claim 3, wherein the substrate comprises aluminum.

5. The table top of claim 1, wherein the substrate comprises tempered glass.

6. The table top of claim 1, wherein the substrate comprises plastic.

7. The table top of claim 1, wherein the substrate comprises autoclaved aerated concrete.

8. The table top of claim 1, wherein the substrate comprises metal composite material.

9. The table top of claim 8, wherein the substrate comprises aluminum composite material.

10. The table top of claim 1, wherein the stone veneer comprises flexible stone veneer.

11. A table top, comprising:
a stone veneer defining a veneer perimeter and having a veneer thickness;
a substrate defining a substrate perimeter and having a substrate thickness; and
an adhesive securing the bottom surface of the stone veneer to the top surface of the substrate;
wherein the veneer perimeter and the substrate perimeter are substantially the same shape;
wherein the veneer thickness is at least 1 millimeter and not greater than 6 millimeters;
wherein the substrate thickness is at least 3 millimeters; and
wherein the table top weighs less than 4 pounds per square foot.

12. The table top of claim 11, wherein the veneer perimeter and the substrate perimeter are rectangular.

13. The table top of claim 11, wherein the veneer perimeter and the substrate perimeter are round.

14. The table top of claim 11, wherein the stone veneer extends past the substrate to form a ledge around the substrate perimeter.

15. The table top of claim 11, wherein the veneer perimeter has a surface area of at least 800 square inches.

16. The table top of claim 11, wherein the substrate comprises aluminum composite material and the stone veneer comprises flexible stone veneer.

17. A table top, comprising:
a stone veneer defining a veneer perimeter and having a veneer thickness;
a substrate defining a substrate perimeter and having a substrate thickness; and
an adhesive securing the bottom surface of the stone veneer to the top surface of the substrate;
wherein the table top weighs less than 4 pounds per square foot.

18. The table top of claim 17, the table top weighs less than 2.5 pounds per square foot.

19. The table top of claim 17, wherein the stone veneer comprises flexible stone veneer.

20. The table top of claim 17, wherein the veneer perimeter and the substrate perimeter are substantially the same shape.
